(19) United States
(12) Patent Application Publication
(10) Pub. No.: US 2020/0143340 A1
(43) Pub. Date: May 7, 2020

(54) FUND FLOW REPORT GENERATION METHOD AND DEVICE

(71) Applicant: Alibaba Group Holding Limited, George Town (KY)

(72) Inventors: Danqing Hu, Hangzhou (CN); Sen Lin, Shanghai (CN)

(73) Assignee: Alibaba Group Holding Limited, George Town (KY)

(21) Appl. No.: 16/723,748

(22) Filed: Dec. 20, 2019

Related U.S. Application Data
(63) Continuation of application No. 16/251,648, filed on Jan. 18, 2019.

(30) Foreign Application Priority Data
Jan. 19, 2018 (CN) 201810055050.8

(51) Int. Cl. G06Q 20/06; H04L 9/06; G06Q 20/02; G06Q 20/36; H04L 9/32

(52) U.S. Cl. CPC G06Q 20/0658; H04L 9/0637; G06Q 20/02; H04L 2209/38; H04L 9/3239; H04L 2209/56; G06Q 20/3672

(57) ABSTRACT

At a regulatory member, a fund flow report generation request is received from a target member associated with a blockchain. Fund flow data associated with the target member is obtained from the blockchain. Based on a parameter in a report template, data corresponding to the parameter in the obtained fund flow data is determined through matching. The matched data is entered into the report template to generate a fund flow report of the target member. The fund flow report is pushed to the target member.

### CROSS-REFERENCE TO RELATED APPLICATIONS

This application is a continuation of U.S. application Ser. No. 16/251,648, filed on Jan. 18, 2019, and claims priority to Chinese Patent Application No. 201810055050.8, filed on Jan. 19, 2018, each of which is hereby incorporated by reference in its entirety.

### TECHNICAL FIELD

Implementations of the present specification relate to the field of blockchain technology, and in particular, to fund flow report generation methods and apparatuses, and an electronic device.

### BACKGROUND

In a fund flow system, reports can be regularly or irregularly provided for a user, and the reports record change details of a member account. Generally, fund flow data is recorded in banks. Therefore, the fund flow system needs to collect fund flow records from each bank, to generate a user's report based on the fund flow records. However, many fund flow records in the banks can relate to user privacy or to information that is disadvantage to the bank. Therefore, the fund flow records provided by the bank usually include some content that is intentionally concealed, modified, deleted, or hidden. As such, the fund flow system may collect problematic fund flow records and consequently, reports generated based on the problematic fund flow records are easy to be fault.

### SUMMARY

Implementations of the present specification provide fund flow report generation methods and apparatuses and an electronic device.

According to a first aspect of the implementations of the present specification, a report generation method is provided, and the method includes: receiving, by a regulatory member, a fund flow report generation request from a target member in a blockchain; obtaining fund flow data of the target member from the blockchain; determining, based on a parameter in a specified report template, data corresponding to the parameter in the obtained fund flow data through matching; writing the matched data to the report template to generate a fund flow report of the target member; and pushing the fund flow report to the target member.

According to a second aspect of the implementations of the present specification, a fund flow report generation method is provided, and the method includes: triggering, by a member in a blockchain, a fund flow report generation instruction; obtaining fund flow data and a report template of the member from the blockchain; determining, based on a parameter in the report template, data corresponding to the parameter in the fund flow data through matching; and writing the matched data to the report template to generate a fund flow report of the target member.

According to a third aspect of the implementations of the present specification, a fund flow report generation apparatus is provided, and the apparatus includes: a receiving unit, configured to receive, at a regulatory member, a fund flow report generation request from a target member in a blockchain; an acquisition unit, configured to obtain fund flow data of the target member from the blockchain; a matching unit, configured to determine, based on a parameter in a specified report template, data corresponding to the parameter in the obtained fund flow data through matching; a generation unit, configured to write the matched data to the report template to generate a fund flow report of the target member; and a push unit, configured to push the fund flow report to the target member.

According to a fourth aspect of the implementations of the present specification, a fund flow report generation apparatus is provided, and the apparatus includes: a triggering unit, configured to trigger, at a member in a blockchain, a fund flow report generation instruction; an acquisition unit, configured to obtain fund flow data and a report template of the member from the blockchain; a matching unit, configured to determine, based on a parameter in the report template, data corresponding to the parameter in the fund flow data through matching; and a generation unit, configured to write the matched data to the report template to generate a fund flow report of the target member.

According to a fifth aspect of the implementations of the present specification, an electronic device is provided, including: a processor; and a memory, configured to store an instruction that can be executed by the processor, where the processor is configured to implement the fund flow report generation method according to any one of the foregoing implementations.

The present specification provides a fund flow system constructed based on blockchain technology Because of the non-tampering characteristic of the blockchain, each piece of fund flow data recorded in the blockchain is authentic and complete. As such, when generating the fund flow report, the fund flow data directly obtained from the blockchain can be authentic and complete. Therefore, the report generated based on such fund flow data is also authentic and complete.

### BRIEF DESCRIPTION OF DRAWINGS

FIG. 1 is a flowchart illustrating a fund flow report generation method, according to an implementation of the present specification;

FIG. 2 is a flowchart illustrating a fund flow report generation method, according to an implementation of the present specification;

FIG. 3 is a schematic diagram illustrating modules in a fund flow report generation apparatus, according to an implementation of the present specification;

FIG. 4 is a schematic diagram illustrating modules in a fund flow report generation apparatus, according to an implementation of the present specification; and

FIG. 5 is a flowchart illustrating an example of a computer-implemented method for generating a fund flow report, according to an implementation of the present disclosure.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Implementations described in the following example implementations do not represent all implementations consistent with the present specification. On the contrary, the implementations are merely examples of apparatuses and methods that are described in detail in the appended claims and consistent with some aspects of the present specification.

The terms used in the present specification are merely for illustrating specific implementations, and are not intended to limit the present specification. The terms “a”, “said”, and “the” of singular forms used in the present specification and the appended claims are also intended to include plural forms, unless otherwise specified in the context clearly. It should also be understood that the term “and/or” used in the present specification indicates and includes any or all possible combinations of one or more associated listed items.

It should be understood that although terms “first”, “second”, “third”, etc. may be used in the present specification to describe various types of information, the information is not limited to the terms. These terms are merely used to differentiate the same type of information. For example, without departing from the scope of the present specification, the first information can also be referred to as the second information, and similarly, the second information can also be referred to as the first information. Depending on the context, for example, the word “if” used here can be explained as “while”, “when”, or “in response to determining”.

Blockchain technology is an emerging technology in which several computing devices jointly participate in “accounting” and jointly maintain a complete distributed database. Because the blockchain technology is characterized by decentralization and transparency, each computing device can participate in database recording, and computing devices can implement rapid data synchronization. A decentralized system constructed by using the blockchain technology and various execution programs stored in a distributed database of a blockchain for automatic execution are widely used in many fields. For example, in the field of financial technologies, a remittance system can be constructed by using the blockchain technology, to implement quick funds transfer. Particularly, during cross-border remittance, the remittance system constructed by using the blockchain technology can implement cooperation between a plurality of participating institutions which have weak trust to each other, such as banks in different countries or regions, so that waiting time of remittance can be reduced, and remittance efficiency can be improved. Because all remittance records are stored in a blockchain ledger in a non-tampering way, it can be ensured that the entire remittance process is transparent and reliable.

In the remittance system provided in the present specification, a blockchain can store several members (Member) of a remittance link and information about other members outside the remittance link. These members can be nodes in the blockchain.

In an implementation, the members of the remittance link can be financial institutions or organizations or platforms in other forms that support a remittance service. Implementations are not limited in the present specification. For example, a financial institution is used as an example, and the members of the remittance link can belong to different institutions (for example, a plurality of banks), or can belong to different branches of a same institution (for example, a plurality of branches of the same bank). Implementations are not limited in the present specification.

Distributed accounting is used in the blockchain, each node stores full accounting information, and the nodes in the blockchain can reach consensus by using a consensus algorithm to jointly maintain a uniform ledger, namely, a blockchain ledger. Therefore, in the present specification, when a certain member reads information from or records information in the blockchain ledger, the member can read information from or record information in full accounting information stored in the member.

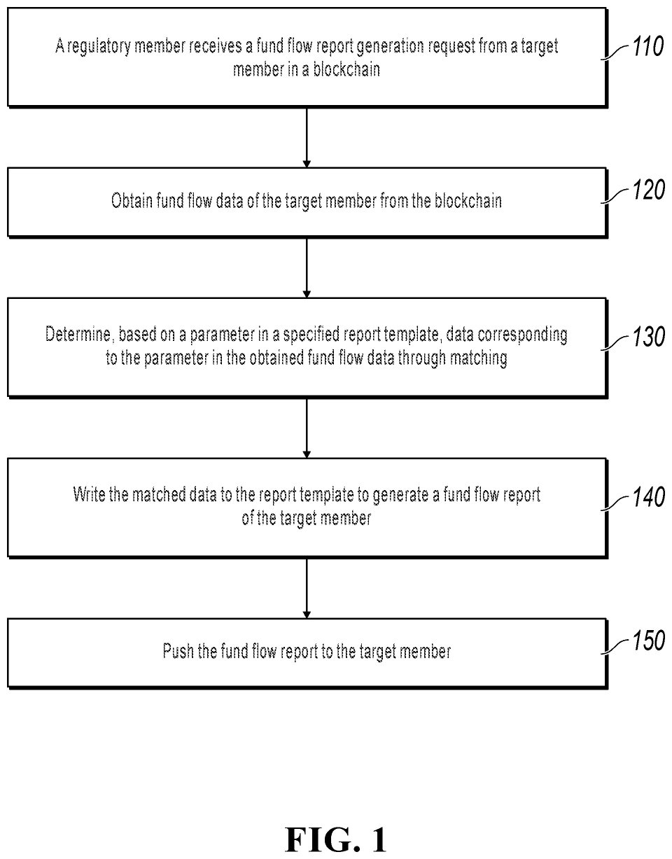

The following describes an implementation of a fund flow report generation method according to the present specification with reference to an example shown in FIG. 1. As shown in FIG. 1, the method can include the following steps.

Step 110: A regulatory member receives a fund flow report generation request from a target member in a blockchain.

In the present implementation, the regulatory member can provide fund flow report services for members in a fund flow system. Generally, the members can send fund flow report generation requests to the regulatory member. After receiving the fund flow report generation request sent by the target member, the regulatory member performs subsequent steps.

In an implementation, the target member is a member that registers with the blockchain and that falls within the jurisdiction of the regulatory member.

In actual applications, there can be a plurality of different regulatory members in one fund flow system, and different regulatory members can regulate different members. For example, during cross-border remittance, a regulatory member in one country can generally regulate only members in that country, but not members in other countries. Therefore, in the blockchain, a correspondence between a regulatory member and a member that falls within the jurisdiction of the regulatory member can be registered in advance. As such, the target member can initiate the report generation request to the regulatory member that regulates the target member, and the regulatory member can perform a fund flow report generation operation on the target member that falls within the jurisdiction of the regulatory member.

In an implementation, a fund flow type can include remittance, payment, receipt, etc.

Step 120: Obtain fund flow data of the target member from the blockchain.

In an implementation, because distributed accounting is used in the blockchain, and each node stores full accounting information, the regulatory member can obtain the fund flow data of the target member from the blockchain.

In an implementation, the fund flow data obtained from the blockchain includes but is not limited to digest data related to a fund flow, digest data of user information, and digest data of transaction-related information.

Before the determining, based on a parameter in a specified report template, data corresponding to the parameter in the obtained fund flow data through matching, the method further includes the following: obtaining detailed data of the fund flow corresponding to the digest data from the target member; and generating, based on the detailed data of the fund flow, second digest data used to check data integrity.

The determining, based on a parameter in a specified report template, data corresponding to the parameter in the obtained fund flow data through matching specifically includes the following: determining, based on the parameter in the specified report template, the data corresponding to the parameter in the detailed data of the fund flow when the second digest data is consistent with the digest data obtained from the blockchain.

In the present implementation, the blockchain does not directly record data related to member privacy, but record only digest data of the privacy data, and the raw data is locally recorded in the member. The digest data can be a digital digest that is obtained through calculation by using a unified algorithm (e.g., a hash algorithm) in the blockchain, and authentic data cannot be read by just using the digital digest. In actual applications, if another member needs to obtain the raw data of the digest information, the member can obtain the raw data from a member corresponding to the digest information. After obtaining the raw data, the member further needs to check data validity, to be specific, calculate digest information of the raw data by using a unified algorithm, and compare the digest information obtained through calculation with digest information in the blockchain. If the digest information obtained through calculation is consistent with the digest information in the blockchain, the obtained raw data is complete. Otherwise, the obtained raw data is abnormal. According to the present implementation, the regulatory member obtaining effective detailed fund data can be ensured.

In an implementation, the obtaining fund flow data of the target member from the blockchain specifically includes the following: initiating a contract operation for obtaining the fund flow data to the blockchain, where the contract operation is used to obtain the fund flow data of the target member from the blockchain.

After joining a smart contract, members in the blockchain can invoke several contract operations supported by the smart contract, for example, the contract operation for “obtaining the fund flow data” here. The regulatory member initiates the contract operation to the blockchain, and can obtain the fund flow data of the target member after the contract operation is implemented.

In an implementation, the request further includes a start moment and an end moment.

The obtaining fund flow data of the target member from the blockchain specifically includes the following: obtaining fund flow data of the target member between the start moment and the end moment from the blockchain.

Step 130: Determine, based on a parameter in a specified report template, data corresponding to the parameter in the obtained fund flow data through matching.

The report template can usually include several parameters. For example, a certain report template can include an operation time, an operation type (receipt, remittance, transfer, payment, etc.), a balance before the operation, a balance after the operation, a net change result (indicating whether the balance increases or decreases), etc. of each fund flow, of a member that is registered in a blockchain ledger. The report template can further include some filtering conditions, for example, obtain only records whose operation amount is greater than RMB 5000.

Step 140: Write the matched data to the report template to generate a fund flow report of the target member.

Step 150: Push the fund flow report to the target member.

The regulatory member can push the fund flow report to the target member based on an address (e.g., IP, or MAC) of the target member that is included in the request.

According to the present implementation, a fund flow system constructed based on blockchain technology is provided. Because of the non-tampering characteristic of the blockchain, each piece of fund flow data recorded in the blockchain is authentic and complete. After the regulatory member receives the fund flow report generation request sent by the target member, the fund flow data directly obtained from the blockchain can be authentic and complete. Therefore, the report generated based on such fund flow data is also authentic and complete.

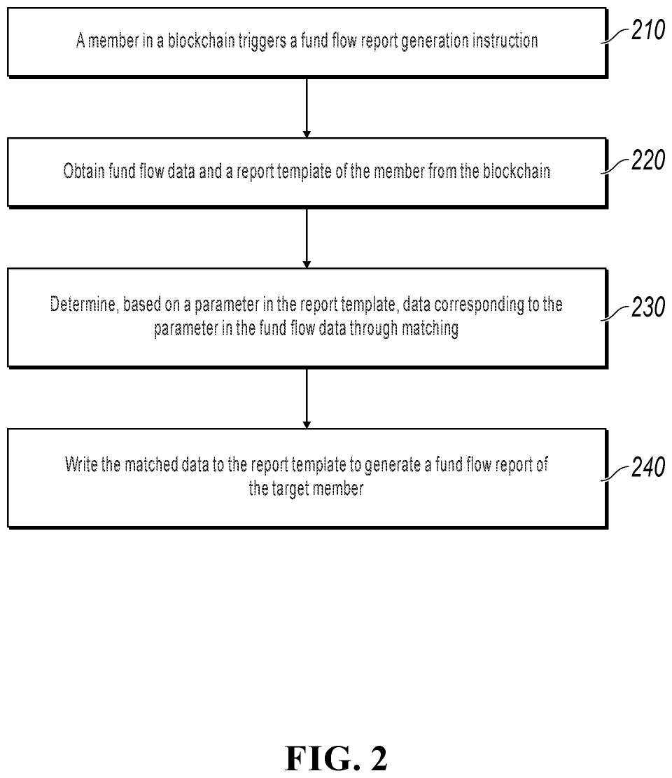

The following describes an implementation of a fund flow report generation method according to the present specification with reference to an example shown in FIG. 2. As shown in FIG. 2, the method can include the following steps.

Step 210: A member in a blockchain triggers a fund flow report generation instruction.

In an implementation, a trigger condition of the fund flow report generation instruction is as follows: a specified period is reached. To be specific, the member in the blockchain can periodically generate fund flow reports. The period can be a predetermined empirical value, for example, one day, one week, or one month.

In an implementation, a trigger condition of the fund flow report generation instruction is as follows: receiving an input fund flow report generation instruction that includes a start moment and an end moment. For example, the member can generate a fund flow report based on an instruction that is input manually.

In an implementation, a fund flow type includes remittance, payment, or receipt.

Step 220: Obtain fund flow data and a report template of the member from the blockchain.

In an implementation, the obtaining fund flow data and a report template of the member from the blockchain specifically includes the following: initiating a contract operation for obtaining the fund flow data to the blockchain, where the contract operation is used to obtain the fund flow data and the report template of the member from the blockchain.

In an implementation, the trigger condition of the fund flow report generation instruction is as follows: the specified period is reached.

The obtaining fund flow data of the member from the blockchain specifically includes the following: obtaining fund flow data of the member in the period from the blockchain.

In an implementation, the trigger condition of the fund flow report generation instruction is as follows: receiving the input fund flow report generation instruction that includes the start moment and the end moment.

The obtaining fund flow data of the member from the blockchain specifically includes the following: obtaining fund flow data of the member between the start moment and the end moment from the blockchain.

In an implementation, the report template is published by a regulatory member in the blockchain.

The regulatory member has a function of publishing report templates. The regulatory member can initiate, to the blockchain, a contract operation of publishing the report template, to broadcast the report template to the blockchain, so that members in the blockchain update report templates that are locally recorded in the blockchain.

It is worthwhile to note that the regulatory member can further modify parameters in the published report template. Similarly, the regulatory member can initiate a contract operation for modifying the parameters in the report template to the blockchain, to broadcast parameters before the modification and modified parameters to the blockchain, so that the members in the blockchain modify parameters in the report templates that are locally recorded in the blockchain.

In an implementation, there can be a plurality of different regulatory members in one fund flow system, and different regulatory members can regulate different members. To be specific, the blockchain may record different report templates published by different regulatory members. Therefore, the obtaining a report template from the blockchain specifically includes the following: obtaining the report template published by a regulatory member corresponding to the member from the blockchain.

Step 230: Determine, based on a parameter in the report template, data corresponding to the parameter in the fund flow data through matching.

In an implementation, the fund flow data obtained from the blockchain includes but is not limited to digest data related to a fund flow, digest data of user information, and digest data of transaction-related information.

Before the determining, based on a parameter in a specified report template, data corresponding to the parameter in the obtained fund flow data through matching, the method further includes the following: locally obtaining detailed data of the fund flow corresponding to the digest data.

Step 230 specifically includes the following: determining, based on the parameter in the report template, the data corresponding to the parameter in the detailed data of the fund flow through matching.

Step 240: Write the matched data to the report template to generate a fund flow report of the target member.

According to the present implementation, a member in the blockchain can generate the fund flow report for itself, and the fund flow report does not need to be generated by the regulatory member as the previous implementation.

Corresponding to the previous implementations of fund flow report generation methods, the present specification further provides implementations of fund flow report generation apparatuses. The apparatus implementations can be implemented by software, hardware, or a combination of hardware and software. Software implementation is used as an example. As a logical apparatus, the apparatus is formed by reading a corresponding computer program instruction in a non-volatile memory to a memory by a processor of a device in which the apparatus is located. In terms of hardware, a hardware structure of a device in which the fund flow report generation apparatus in the present specification is located can include a processor, a network interface, a memory, and a non-volatile memory, and the device in which the apparatus in the implementation is located can further include other hardware based on actual functions of generating a fund flow report. Details are omitted here for simplicity.

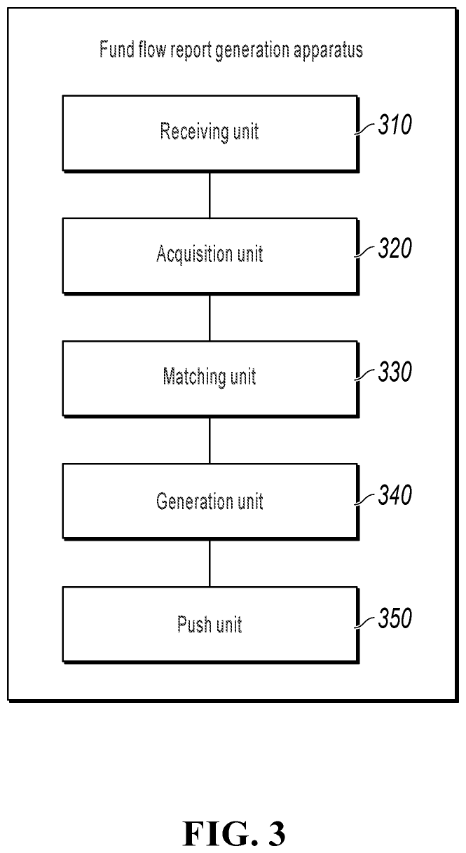

Referring to FIG. 3, FIG. 3 is a diagram of modules in a fund flow report generation apparatus according to an implementation of the present specification. The apparatus corresponds to the implementation shown in FIG. 1, and the apparatus includes the following: a receiving unit 310, configured to receive, at a regulatory member, a fund flow report generation request from a target member in a blockchain; an acquisition unit 320, configured to obtain fund flow data of the target member from the blockchain; a matching unit 330, configured to determine, based on a parameter in a specified report template, data corresponding to the parameter in the obtained fund flow data through matching; a generation unit 340, configured to write the matched data to the report template to generate a fund flow report of the target member; and a push unit 350, configured to push the fund flow report to the target member.

In an optional implementation, the fund flow data obtained from the blockchain is digest data related to a fund flow.

Before the matching unit 330, the apparatus includes the following: an acquisition subunit, configured to obtain detailed data of the fund flow corresponding to the digest data from the target member; and a generation subunit, configured to generate, based on the detailed data of the fund flow, second digest data used to check data integrity.

The matching unit 330 is specifically configured to: determine, based on the parameter in the specified report template, the data corresponding to the parameter in the detailed data of the fund flow when the second digest data is consistent with the digest data obtained from the blockchain.

In an optional implementation, the acquisition unit 320 is specifically configured to initiate a contract operation for obtaining the fund flow data to the blockchain, where the contract operation is used to obtain the fund flow data of the target member from the blockchain.

In an optional implementation, the request further includes a start moment and an end moment.

The acquisition unit 320 is specifically configured to obtain fund flow data of the target member between the start moment and the end moment from the blockchain.

In an optional implementation, the target member is a member that registers with the blockchain and that falls within the jurisdiction of the regulatory member.

In an optional implementation, a fund flow type includes remittance, payment, or receipt.

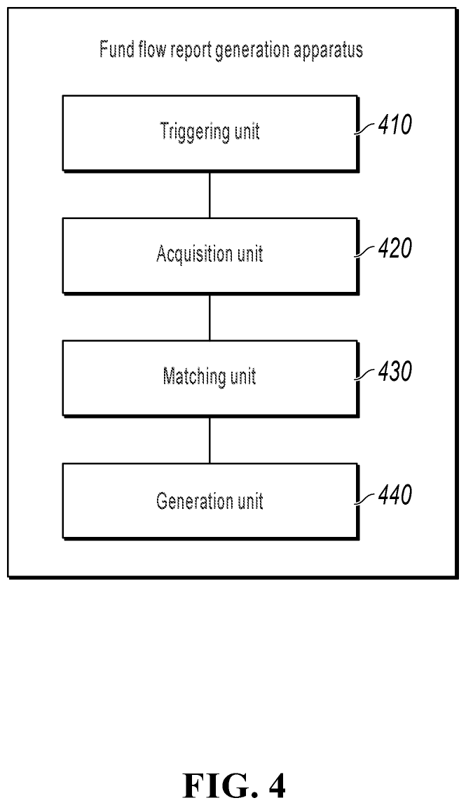

Referring to FIG. 4, FIG. 4 is a diagram of modules in a fund flow report generation apparatus according to an implementation of the present specification. The apparatus corresponds to the implementation shown in FIG. 2, and the apparatus includes the following: a triggering unit 410, configured to trigger, at a member in a blockchain, a fund flow report generation instruction; an acquisition unit 420, configured to obtain fund flow data and a report template of the member from the blockchain; a matching unit 430, configured to determine, based on a parameter in the report template, data corresponding to the parameter in the fund flow data through matching; and a generation unit 440, configured to write the matched data to the report template to generate a fund flow report of the target member.

In an optional implementation, the fund flow data obtained from the blockchain is digest data related to a fund flow.

Before the matching unit 430, the apparatus further includes the following: an acquisition subunit, configured to locally obtain detailed data of the fund flow corresponding to the digest data.

The matching unit 430 is specifically configured to determine, based on the parameter in the specified report template, the data corresponding to the parameter in the detailed data of the fund flow through matching.

In an optional implementation, the acquisition unit 420 is specifically configured to initiate a contract operation for obtaining the fund flow data to the blockchain, where the contract operation is used to obtain the fund flow data and the report template of the member from the blockchain.

In an optional implementation, a trigger condition of the fund flow report generation instruction is as follows: a specified period is reached.

The acquisition unit 420 is specifically configured to obtain fund flow data of the member in the period from the blockchain.

In an optional implementation, a trigger condition of the fund flow report generation instruction is as follows: receiving an input fund flow report generation instruction that includes a start moment and an end moment.

The acquisition unit 420 is specifically configured to obtain fund flow data of the member between the start moment and the end moment from the blockchain.

In an optional implementation, the report template is published by a regulatory member in the blockchain.

In an optional implementation, the acquisition unit 420 is specifically configured to obtain the report template published by a regulatory member corresponding to the member from the blockchain.

In an optional implementation, a fund flow type includes remittance, payment, or receipt.

The system, apparatuses, modules, or units described in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

For an implementation process of functions and roles of units in the previous apparatuses, references can be made to implementation processes of corresponding steps in the previous methods. Details are omitted here for simplicity.

Because an apparatus implementation basically corresponds to a method implementation, for related parts, references can be made to related descriptions in the method implementation. The previously described apparatus implementations are merely examples. The units described as separate parts may or may not be physically separate, and parts displayed as units may or may not be physical units, may be located in one position, or may be distributed on a plurality of network units. Some or all of the modules can be selected based on actual needs to achieve the objectives of the solutions in the present specification. A person of ordinary skill in the art can understand and implement the implementations of the present specification without creative efforts.

FIG. 3 describes internal function modules and a structure of a report generation apparatus. Actually, an execution body of the report generation apparatus can be an electronic device, including: a processor; and a memory, configured to store an instruction that can be executed by the processor.

The processor is configured to receive, at a regulatory member, a fund flow report generation request from a target member in a blockchain; obtain fund flow data of the target member from the blockchain; determine, based on a parameter in a specified report template, data corresponding to the parameter in the obtained fund flow data through matching; write the matched data to the report template to generate a fund flow report of the target member; and push the fund flow report to the target member.

Optionally, the fund flow data obtained from the blockchain is digest data related to a fund flow.

Before determining, based on the parameter in the specified report template, the data corresponding to the parameter in the obtained fund flow data through matching, the processor is further configured to obtain detailed data of the fund flow corresponding to the digest data from the target member, and generate, based on the detailed data of the fund flow, second digest data used to check data integrity.

The determining, based on a parameter in a specified report template, data corresponding to the parameter in the obtained fund flow data through matching specifically includes the following: determining, based on the parameter in the specified report template, the data corresponding to the parameter in the detailed data of the fund flow when the second digest data is consistent with the digest data obtained from the blockchain.

Optionally, the obtaining fund flow data of the target member from the blockchain specifically includes the following: initiating a contract operation for obtaining the fund flow data to the blockchain, where the contract operation is used to obtain the fund flow data of the target member from the blockchain.

Optionally, the request further includes a start moment and an end moment.

The obtaining fund flow data of the target member from the blockchain specifically includes the following: obtaining fund flow data of the target member between the start moment and the end moment from the blockchain.

Optionally, the target member is a member that registers with the blockchain and that falls within the jurisdiction of the regulatory member.

Optionally, a fund flow type includes remittance, payment, or receipt.

FIG. 4 describes internal function modules and a structure of a report generation apparatus. Actually, an execution body of the report generation apparatus can be an electronic device, including: a processor; and a memory, configured to store an instruction that can be executed by the processor.

The processor is configured to trigger, at a member in a blockchain, a fund flow report generation instruction; obtain fund flow data and a report template of the member from the blockchain; determine, based on a parameter in the report template, data corresponding to the parameter in the fund flow data through matching; and write the matched data to the report template to generate a fund flow report of the target member.

Optionally, the fund flow data obtained from the blockchain is digest data related to a fund flow.

Before determining, based on the parameter in the specified report template, the data corresponding to the parameter in the obtained fund flow data through matching, the processor is further configured to locally obtain detailed data of the fund flow corresponding to the digest data.

The determining, based on a parameter in the report template, data corresponding to the parameter in the obtained fund flow data through matching specifically includes the following: determining, based on the parameter in the report template, the data corresponding to the parameter in the detailed data of the fund flow through matching.

Optionally, the obtaining fund flow data and a report template of the member from the blockchain specifically includes the following: initiating a contract operation for obtaining the fund flow data to the blockchain, where the contract operation is used to obtain the fund flow data and the report template of the member from the blockchain.

Optionally, a trigger condition of the fund flow report generation instruction is as follows: a specified period is reached.

The obtaining fund flow data of the member from the blockchain specifically includes the following: obtaining fund flow data of the member in the period from the blockchain.

Optionally, a trigger condition of the fund flow report generation instruction is as follows: receiving an input fund flow report generation instruction that includes a start moment and an end moment.

The obtaining fund flow data of the member from the blockchain specifically includes the following: obtaining fund flow data of the member between the start moment and the end moment from the blockchain.

Optionally, the report template is published by a regulatory member in the blockchain.

Optionally, the obtaining a report template from the blockchain specifically includes the following: obtaining the report template published by a regulatory member corresponding to the member from the blockchain.

Optionally, a fund flow type includes remittance, payment, or receipt.

In the previous implementations of electronic devices, it should be understood that the processor can be a central processing unit (CPU), another general purpose processor, a digital signal processor (DSP), an application-specific integrated circuit (ASIC), etc. The general purpose processor can be a microprocessor or the processor can be any conventional processor. The previously described memory can be a read-only memory (ROM), a random access memory (RAM), a flash memory, a hard disk, or a solid state disk. The steps of the methods disclosed in the implementations of the present disclosure can be directly performed by a hardware processor, or performed by a combination of hardware and software modules in a processor.

The implementations in the present specification are described in a progressive way. For same or similar parts in the implementations, references can be made to the implementations. Each implementation focuses on a difference from other implementations. Particularly, an implementation of an electronic device is basically similar to a method implementation, and therefore, is described briefly. For related parts, references can be made to related descriptions in the method implementation.

A person skilled in the art can easily figure out another implementation of the present specification after considering the specification and practicing the present disclosure disclosed here. The present specification is intended to cover any variations, functions, or adaptive changes of the present specification. These variations, functions, or adaptive changes comply with general principles of the present specification, and include common knowledge or a commonly used technical means in the technical field that is not disclosed in the present specification. The specification and the implementations are merely considered as examples, and the actual scope and the spirit of the present specification are described by the following claims.

It should be understood that the present specification is not limited to the precise structures that have been described above and shown in the drawings, and various modifications and changes can be made without departing from the scope of the present specification. The scope of the present specification is limited by the appended claims only.

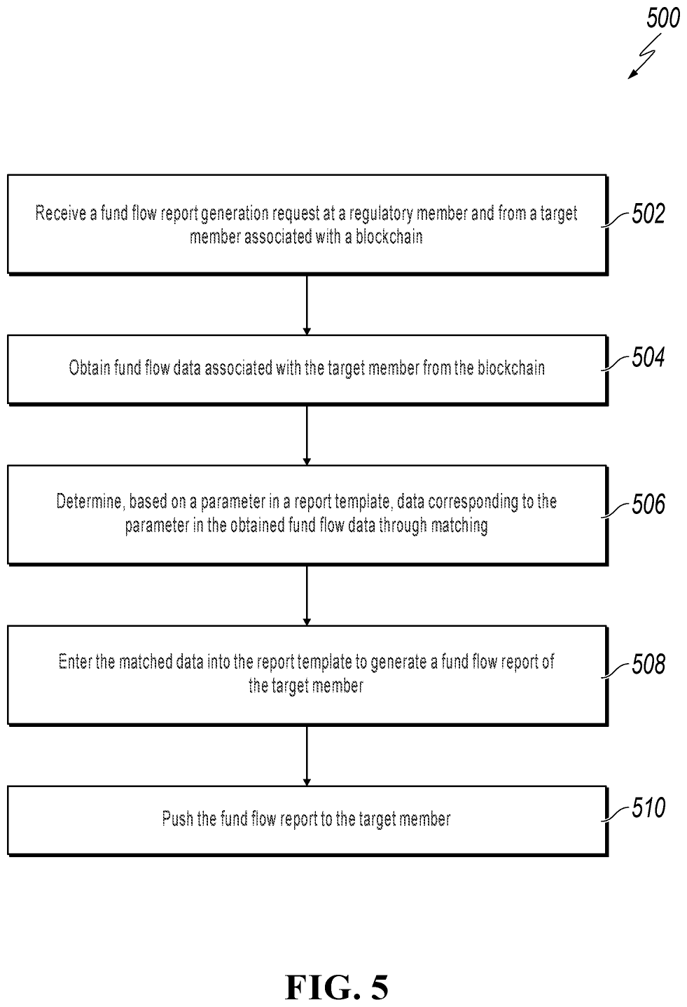

FIG. 5 is a flowchart illustrating an example of a computer-implemented method 500 for generating a fund flow report, according to an implementation of the present disclosure. For clarity of presentation, the description that follows generally describes method 500 in the context of the other figures in this description. However, it will be understood that method 500 can be performed, for example, by any system, environment, software, and hardware, or a combination of systems, environments, software, and hardware, as appropriate. In some implementations, various steps of method 500 can be run in parallel, in combination, in loops, or in any order.

At 502, a fund flow report generation request is received at a regulatory member and from a target member associated with a blockchain. In some implementations, the request further comprises a start moment and an end moment, where obtaining fund flow data associated with the target member comprises obtaining fund flow data from the blockchain associated with the target member between the start moment and the end moment. In some implementations, the target member registers with the blockchain and falls within a jurisdiction of the regulatory member. From 502, method 500 proceeds to 504.

At 504, fund flow data associated with the target member is obtained from the blockchain. In some implementation, the fund flow data includes digest data associated with a fund flow, user information, and transaction-related information. In such implementations, prior to determining data corresponding to the parameter in the obtained fund flow data, method 500 further includes obtaining detailed data associated with the fund flow corresponding to the digest data from the target member; and generating, based on the detailed data of the fund flow, second digest data used to check data integrity.

In some implementations, obtaining fund flow data associated with the target member from the blockchain includes initiating a contract operation for obtaining the fund flow data from the blockchain, where the contract operation is used to obtain the fund flow data associated with the target member from the blockchain. From 504, method 500 proceeds to 506.

At 506, data corresponding to the parameter in the obtained fund flow data is determined through matching based on a parameter in a report template.

In some implementations, determining the data corresponding to the parameter in the obtained fund flow data includes determining, based on the parameter in the report template, data corresponding to the parameter in the detailed data associated with the fund flow when the second digest data is consistent with the digest data obtained from the blockchain. From 506, method 500 proceeds to 508.

At 508, the matched data is entered into the report template to generate a fund flow report of the target member. From 508, method 500 proceeds to 510.

At 510, the fund flow report is pushed to the target member. After 510, method 500 stops.

Implementations of the present application can solve one or more technical problems in generating a fund flow report. Traditionally, because fund flow data is recorded in banks, to generate fund flow reports, the fund flow system needs to collect fund flow records from each bank and to generate a user's report based on the collected records. However, many fund flow records in the banks relate to user privacy or to information that is considered to be sensitive to the banks. Therefore, banks usually intentionally conceal, modify, delete, or hide some data information when providing the fund flow records. Consequently, fund flow reports generated based on the fund flow records are not accurate or reliable. What is needed is a technique to bypass or mitigate these problems in traditional methods, and to provide a more secure and unified solution for generating a fund flow report based on users' fund flow records.

Implementations of the present application provide methods and apparatuses for improving fund report generation by conducting a fund flow system based on blockchain technology. In some implementations, a regulatory member of the blockchain can directly obtain fund flow records associated with a user from blockchain ledgers and generate a fund flow report for the user based on the fund flow records. The described subject matter takes advantage of a distributed accounting feature of blockchain technology and provides several technical effects/advantages. First, instead of recording full data information of a user, each blockchain only records a data digest associated with the full data information. The data digest can be a digital digest that is obtained through calculation by using a unified algorithm (for example, a hash algorithm) in the blockchain. Because the original data information cannot be recovered from the data digest, user privacy is preserved, banks are more willing to provide complete fund flow records to the regulatory member, and a fund flow report generated based on the fund flow records is more accurate. Further, because of the non-tampering characteristic of blockchain technology, each piece of fund flow data recorded in the blockchain can be considered to be authentic and complete. Therefore, reports generated based on such fund flow data can also be considered to be authentic and complete.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving, at a regulatory member, a fund flow report generation request from a target member associated with a blockchain;
obtaining fund flow data associated with the target member from the blockchain;
determining, based on a parameter in a report template, data corresponding to the parameter in the obtained fund flow data through matching;
entering the matched data into the report template to generate a fund flow report of the target member; and
pushing the fund flow report to the target member.

2. The computer-implemented method of claim 1, wherein the fund flow data obtained from the blockchain includes digest data associated with a fund flow, user information, and transaction-related information.

3. The computer-implemented method of claim 2, further comprising:
prior to determining data corresponding to the parameter in the obtained fund flow data:
obtaining detailed data associated with the fund flow corresponding to the digest data from the target member; and
generating, based on the detailed data of the fund flow, second digest data used to check data integrity.

4. The computer-implemented method of claim 3, wherein determining the data corresponding to the parameter in the obtained fund flow data comprises:
determining, based on the parameter in the report template, data corresponding to the parameter in the detailed data associated with the fund flow when the second digest data is consistent with the digest data obtained from the blockchain.

5. The computer-implemented method of claim 1, wherein obtaining fund flow data associated with the target member from the blockchain comprises:
initiating a contract operation for obtaining the fund flow data from the blockchain, wherein the contract operation is used to obtain the fund flow data associated with the target member from the blockchain.

6. The computer-implemented method of claim 1, wherein the request further comprises a start moment and an end moment, and wherein obtaining fund flow data associated with the target member comprises obtaining fund flow data from the blockchain associated with the target member between the start moment and the end moment.

7. The computer-implemented method of claim 1, wherein the target member registers with the blockchain and falls within a jurisdiction of the regulatory member.

8. A non-transitory, computer-readable medium storing one or more instructions executable by a computer system to perform operations comprising:
receiving, at a regulatory member, a fund flow report generation request from a target member associated with a blockchain;
obtaining fund flow data associated with the target member from the blockchain;
determining, based on a parameter in a report template, data corresponding to the parameter in the obtained fund flow data through matching;
entering the matched data into the report template to generate a fund flow report of the target member; and
pushing the fund flow report to the target member.

9. The non-transitory, computer-readable medium of claim 8, wherein the fund flow data obtained from the blockchain includes digest data associated with a fund flow, user information, and transaction-related information.

10. The non-transitory, computer-readable medium of claim 9, further comprising:
prior to determining data corresponding to the parameter in the obtained fund flow data:
obtaining detailed data associated with the fund flow corresponding to the digest data from the target member; and
generating, based on the detailed data of the fund flow, second digest data used to check data integrity.

11. The non-transitory, computer-readable medium of claim 10, wherein determining the data corresponding to the parameter in the obtained fund flow data comprises:
determining, based on the parameter in the report template, data corresponding to the parameter in the detailed data associated with the fund flow when the second digest data is consistent with the digest data obtained from the blockchain.

12. The non-transitory, computer-readable medium of claim 8, wherein obtaining fund flow data associated with the target member from the blockchain comprises:
initiating a contract operation for obtaining the fund flow data from the blockchain, wherein the contract operation is used to obtain the fund flow data associated with the target member from the blockchain.

13. The non-transitory, computer-readable medium of claim 8, wherein the request further comprises a start moment and an end moment, and wherein obtaining fund flow data associated with the target member comprises obtaining fund flow data from the blockchain associated with the target member between the start moment and the end moment.

14. The non-transitory, computer-readable medium of claim 8, wherein the target member registers with the blockchain and falls within a jurisdiction of the regulatory member.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, at a regulatory member, a fund flow report generation request from a target member associated with a blockchain;
obtaining fund flow data associated with the target member from the blockchain;
determining, based on a parameter in a report template, data corresponding to the parameter in the obtained fund flow data through matching;
entering the matched data into the report template to generate a fund flow report of the target member; and
pushing the fund flow report to the target member.

16. The computer-implemented system of claim 15, wherein the fund flow data obtained from the blockchain includes digest data associated with a fund flow, user information, and transaction-related information.

17. The computer-implemented system of claim 16, further comprising:
prior to determining data corresponding to the parameter in the obtained fund flow data:
obtaining detailed data associated with the fund flow corresponding to the digest data from the target member; and
generating, based on the detailed data of the fund flow, second digest data used to check data integrity.

18. The computer-implemented system of claim 17, wherein determining the data corresponding to the parameter in the obtained fund flow data comprises:
determining, based on the parameter in the report template, data corresponding to the parameter in the detailed data associated with the fund flow when the second digest data is consistent with the digest data obtained from the blockchain.

19. The computer-implemented system of claim 15, wherein obtaining fund flow data associated with the target member from the blockchain comprises:
initiating a contract operation for obtaining the fund flow data from the blockchain, wherein the contract operation is used to obtain the fund flow data associated with the target member from the blockchain.

20. The computer-implemented system of claim 15, wherein the request further comprises a start moment and an end moment, and wherein obtaining fund flow data associated with the target member comprises obtaining fund flow data from the blockchain associated with the target member between the start moment and the end moment.
